(19) United States
(12) Patent Application Publication
(10) Pub. No.: US 2008/0171659 A1
(43) Pub. Date: Jul. 17, 2008

(54) Insecticidally Coated Fertilizer Solids

(76) Inventors: Kenneth E. Fersch, Apex, NC (US); Shannon M. Russell, Durham, NC (US)

Correspondence Address: ROYLANCE, ABRAMS, BERDO & GOODMAN, L.L.P., 1300 19TH STREET, N.W., SUITE 600, WASHINGTON,, DC, 20036, US

(21) Appl. No.: 11/624,011

(22) Filed: Jan. 17, 2007

(51) Int. Cl. C05G 3/02

(52) U.S. Cl. 504/101

(57) ABSTRACT

An insecticidal fertilizer composition is prepared by contacting fertilizer solids with a coating composition that contains a spreading oil and an insecticide.

### FIELD OF THE INVENTION

Insecticidal fertilizer solids are disclosed that contain an agrochemically effective plant fertilizer-containing solid that has been contacted with an insecticidally effective coating composition containing an effective amount of an insecticide, such as the nicotinyl insecticides. The insecticidal fertilizer is a substantially dry solid fertilizer that contains an effective amount of the insecticide absorbed into or adsorbed on the solid fertilizer.

### BACKGROUND OF THE INVENTION

Insecticides that are agonists and antagonists of the nicotinergic acetylcholine receptors are disclosed in U.S. Pat. No. 4,742,060 (issued May 3, 1988). These insecticides have also been found useful as dermally applied insecticides. See, U.S. Pat. No. 6,232,328. These compounds are also very effective as systemic insecticides in plants. It has been found to be advantageous to co-apply these insecticides with an agrochemically effective fertilizer. One example is disclosed in U.S. Pat. No. 5,783,203.

U.S. Pat. No. 5,783,203 discloses a composition and processes for mixing solids that contain an agonist or antagonist of a nicotinergic acetylcholine receptor of insects (e.g., imidacloprid insecticide) with fertilizer solids. This is taught to be done by either compressing or extruding the insecticidal solids with the fertilizer or attaching it to the fertilizer with an adhesive binder.

The processes for achieving U.S. Pat. No. 5,783,203 are typically cumbersome and costly. As taught in that invention, numerous solids of different ingredients must be blended together. The production on a tablet, stick, granule requires a costly compression or extrusion process that is often coupled with a fluid bed dryer. Oversized and undersize product must each be separated and then recycled with granulation processes into subsequent batches.

A combining process that relies on an adhesive for insecticidal solids requires that the ingredients be milled to a very small particle size so that they will stay attached to the granule by the adhesive. In addition to a costly process step, milling to such a small particle size can create a dusty environment increasing the health risk to operators. Milling, compression, extrusion, and drying processes along with their support systems such as steam, chilled water, dust containment, etc. are capital intensive and have high operating costs.

Nonetheless, compositions that contain a spreading oil and a finely divided insecticidal solid have found usefulness and commercial acceptance in the area of dermally applied insecticide formulations for humans and warm-blooded mammals and for the dispersal of insecticides in aqueous environments. See, e.g., U.S. Pat. No. 4,874,753 (dermal oil for dogs), U.S. Pat. No. 6,387,848 (water dispersal formulation)

The present inventors wondered whether a spreading oil conventionally used for dermal application of insecticides could be used with insecticides, including imidacloprid and chemically related nicotinyl insecticides, for coating of fertilizer granules for co-application of fertilizers and insecticides. A coating composition containing the spreading oil and insecticide could be sprayed directly onto carrier solids containing plant fertilizer components and absorbed or adsorber thereon for intimate mixture and uniform co-application. This would be a very simple and cost effective process and would yield a product capable of very high nutrient values (>97% of the product as fertilizer).

U.S. Pat. No. 5,783,203 mentions acetone as a solvent for imidacloprid. Acetone was found to have a solubility of less than 7 wt % imidacloprid. Using a 6 wt % imidacloprid in acetone would mean applying 1.67 wt % of the solution on the fertilizer based on the combined weight of the fertilizer and the solution to achieve a product with 0.10 wt % imidacloprid. This would be very difficult to achieve a dry product. Fertilizer products with 0.2 wt % and 0.5 wt % imidacloprid would require 3.33 wt % and 8.33 wt % respectively of the imidacloprid solution absorbed onto the fertilizer; concentrations which are not likely feasible in acetone. In addition, acetone is volatile and highly flammable which would make processing very difficult and expensive.

Accordingly, there is a continuing need in the industry for a process for producing a fertilizer composition containing a co-applied insecticide composition.

### SUMMARY OF THE INVENTION

It is an object of the invention to provide a process for producing an effective, insecticidally active, fertilizer solid and to the resulting insecticidally active fertilizer.

It is a further object of the invention to provide an effective fertilizer composition for plants that includes an insecticidally effective nicotinyl component that is adsorbed or absorbed therein.

In accordance with these and other objects of the invention that will become apparent from the description herein, a coating composition containing a spreading oil and an insecticidally active compound is contacted with a solid fertilizer so that the fertilizer contains an effective amount of the insecticide.

The various aspects of the invention are basically attained by providing a dry fertilizer composition containing about 0.1 wt % to about 1.0 wt % insecticide based on the total weight of the fertilizer composition.

The aspects of the invention are further attained by providing a process for producing a free-flowing fertilizer solid composition by mixing or contacting a solid fertilizer with a coating composition containing a spreading oil and an insecticide dissolved or dispersed therein. The coating composition is supplied in an amount to provide an effective amount of the insecticide in the fertilizer. The coating composition is preferably applied to the fertilizer in an amount of 0.5 wt % to about 3.0 wt % based on the weight of the solid fertilizer.

The aspects of the invention are also provided by: (a) forming a coating composition that contains a spreading oil and at least about 10 wt % of the insecticide, and (b) contacting the fertilizer with the coating composition to produce a dry fertilizer composition containing about 0.1 % to about 1.0 wt % insecticide based on the weight of the composition. In one embodiment, the coating composition contains a nonvolatile liquid spreading oil and an insecticide such as nicotinyl antagonist insecticide like imidacloprid or a related insecticidally effective compound.

Other aspects and advantages of the invention will become apparent from the following detailed description of the invention which disclose various embodiments of the invention.

### DETAILED DESCRIPTION OF THE INVENTION

The present invention is directed to a process for producing an insecticidal fertilizer and to the resulting composition. The invention is further directed to a coating composition that contains a liquid spreading oil with an effective amount of an insecticide that is dispersed or dissolved in the spreading oil in a form suitable for direct application to particulate fertilizer solids or mixtures of fertilizer solids of differing compositions.

The insecticidal fertilizer of the invention is preferably a free-flowing granular composition that contains an insecticide in an effective amount to treat the soil with the fertilizer composition while controlling the insect population. Preferably, the insecticide is included in an amount corresponding to the desired application rate of the fertilizer for a selected surface area so that the fertilizer composition can be applied at an effective rate for both the fertilizer and the insecticide.

The process of the invention applies a coating composition that contains a spreading oil and an insecticidally effective compound or composition to a solid, particulate fertilizer in an amount that can be coated onto the surface of the fertilizer. Preferably, the insecticidal coating composition is applied to the particulate fertilizer in an amount that can be adsorbed/absorbed without causing the solids to become subject to clumping or agglomeration.

The insecticide is contacted with or applied to the fertilizer particles in a manner to produce a substantially dry, free-flowing granular or particulate insecticidal fertilizer. Preferably, the process produces a substantially dry composition without the need for flow aids or other materials to reduce solids agglomeration.

The insecticide is preferably applied to the solid fertilizer by spraying or dripping. The insecticide can be applied in a batch process by continuously mixing the solid fertilizer particles while spraying or dripping the insecticide into the mixing vessel. In another embodiment, the insecticide is sparyed or dripped onto a moving bed of the solid fertilizer.

The insecticide according to one embodiment of the invention is applied in a composition that contains a nonvolatile spreading oil and a sufficient amount of the insecticide. Spreading oils that can be used in the present invention are generally those that have been found to be acceptable for dermal contact and which remain in liquid form at temperatures up to about 40° C. Spreading oils of the invention are preferably not generally characterizable as good solvents for the applied insecticide although the spreading oil may have some, e.g., less than about 15 wt % solvation effect on the insecticidal solids used in the present invention. Preferred spreading oils for use in the invention specifically include 2-octyidodecanol or oleyl acholol, esters of monocarboxylic acids (such as isopropyl myristate, isopropyl palmitate, lauric acid oxalate, oleic acid oleyl ester, oleic acid decyl ester, hexyl laurate, oleyl oleate, decyl oleate, capric acid esters of saturated fat alcohols of chain length C₁₂-C₁₈), dibutyl phthalate, diisopropyl isophthalate, adipic acid diisopropyl ester, di-n-butyl adipate, cyclic and acyclic silicone oils (e.g., dimethicones), isopropyl palmitate, caprylic/capric acid triglyceride, saturated triglycerides of naturally occurring fatty acids, fatty acid esters (e.g., ethyl oleate), fatty acid esters which correspond to synthetic anatine uropygial gland fat, triglycerides, fatty alcohols, aliphatic hydrocarbons (e.g., light paraffin oil), vegetable oils that are traditionally not included in the definition of spreading oils (e.g., corn, sesame, olive, pine, linseed, cottonseed and ground nut oil), and derivatives thereof with cationic and anionic functional groups. Spreading oils according to the present invention do not include, and expressly exclude, dipropylene glycol.

The insecticides useful in the present invention include any insecticides that can be applied safely in the locus of seeds, plat roots, or plant tissues. An expecially preferred insecticide is an agonist or antagonist or the nicotinergic acetylcholine receptors of insects, such as those having the formula

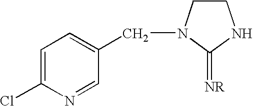

wherein R is NO₂ or CN. Other nicotinyl insecticides that can be used are those as disclosed in U.S. Pat. No. 5,783,203 and U.S. Pat. No. 4,742,060. A particularly preferred insecticide is imidacloprid, 1-((6-chloro-3-pyridinyl)methyl-N-nitro-2-imidazolidinimine.

In one embodiment, a coating composition is prepared from a spreading oil and about 10 wt % to about 85 wt % insecticide, and typically about 10 wt % to about 50 wt %. In another embodiment, the coating composition contains about 10 wt % to about 35 wt % of the insecticide and, in particular, imidacloprid. In further embodiments, the coating composition contains about 15 wt % to about 25 wt % of dispersed and/or dissolved insecticide.

The fertilizer solids can be organic or inorganic compounds, or mixtures of solids having different compositions. Examples of fertilizer components include the nitrogen-containing compounds such as urea, sulfur-coated urea, urea-formaldehyde condensation products, amino acids, ammonium salts and nitrates. Other fertilizer compounds include potassium salts such as potassium chloride, potassium sulfate, potassium nitrates, potassium and ammonium salts of phosphoric acid. The fertilizer can also contain nutrients such as manganese, magnesium, iron, boron, copper zinc, molybdenum, and cobalt. In other embodiments, the fertilizer can include phytohormones such as vitamin B₁ and idole-III-acetic acid.

The fertilizer is a solid particle in the form of pellets, granules, flakes, and the like. Commercially available fertilizers that are suitable include nitrogen, potassium, phosphorous and combinations thereof in various amounts as known in the art. Typical amounts of the components are about 0-30 wt % nitrogen compounds, 0-50 wt % phosphorous compounds and 0-50 wt % potassium compounds. A typical blend of these components might be something like 21-3-8 weight percent nitrogen, phosphorous pentoxide (P₂O₅), and potassium oxide (K₂O) respectively.

The process of the invention contacts the solid fertilizer particles with a coating composition containing the insecticide by spraying, dripping or other suitable solid-liquid contact process. The insecticide coating composition preferably contains at least 10 wt % of dispersed and/or partially dissolved insecticide. The coating composition is contacted with the fertilizer in an amount of about 0.5 wt % to about 3.0 wt %, and typically in the amount of about 0.5 wt % to about 2.0 wt % based on the weight of the fertilizer. Applying the insecticidal coating composition in these amounts provides an effective amount of the insecticide without the fertilizer solids becoming wet or subject to undue clumping or agglomeration.

The insecticide concentration in the finished fertilizer is at least 0.1 wt % and typically in the range of about 0.1 wt % to about 1.0 wt % based on the weight of the insecticidal fertilizer composition. In one embodiment, the finished fertilizer contains about 0.1 wt % to about 0.5 wt % insecticide and preferably 0.2 wt % to about 0.5 wt % insecticide based on the weight of the insecticidal fertilizer composition.

Preferably, the coating composition is contacted with the solid fertilizer to provide an effective amount of the insecticide without drying or the use of flow aids. In embodiments where higher amounts of the insecticide are desired, a flow aid such as diatomaceous earth can be added.

While various embodiments have been chosen to illustrate the invention, it will be apparent that the various changes and modifications can be made without departing from the scope of the invention as defined in the appended claims.

What is claimed is:

1. A process for producing a fertilizer composition, said process comprising:
mixing fertilizer solids with a coating composition containing a spreading oil and an insecticide.

2. A process according to claim 1 wherein said spreading oil comprises 2-octyidodecanol or oleyl alcohol, esters of monocarboxylic acids, dibutyl phthalate, diisopropyl isophthalate, adipic acid diisopropyl ester, di-n-butyl adipate, cyclic and acyclic silicone oils, isopropyl palmitate, caprylic/capric acid triglyceride, saturated triglycerides of naturally occurring fatty acids, fatty acid esters, fatty acid esters which correspond to synthetic anatine uropygial gland fat, triglycerides, fatty alcohols, aliphatic hydrocarbons, vegetable oils, or derivatives thereof with cationic or anionic functional groups.

3. A process according to claim 1 wherein said spreading oil comprises isopropyl myristate, isopropyl palmitate, lauric acid oxalate, oleic acid oleyl ester, oleic acid decyl ester, hexyl laurate, oleyl oleate, decyl oleate, or capric acid esters of saturated fat alcohols of chain length C₁₂-C₁₈.

4. A process according to claim 1 wherein said spreading oil comprises ethyl oleate, a paraffin oil, or corn oil, sesame oil, olive oil, pine oil, linseed oil, cottonseed oil, or ground nut oil.

5. The process of claim 1, wherein said insecticide comprises imidacloprid.

6. The process of claim 1, wherein said fertilizer solids comprise sulfur-coated urea and another solids containing a different fertilizer composition.

7. A particulate fertilizer composition comprising fertilizer solids coated with a coating composition that comprises a spreading oil and an insecticide.

8. The composition of claim 7, wherein said fertilizer solids comprise sulfur-coated urea and a different particulate fertilizer.

9. The composition of claim 7 wherein said spreading oil comprises dipropylene glycol monomethylether, dipropylene glycol pelargonate, 2-octyidodecanol or oleyl alcohol, esters of monocarboxylic acids, dibutyl phthalate, diisopropyl isophthalate, adipic acid diisopropyl ester, di-n-butyl adipate, cyclic and acyclic silicone oils, isopropyl palmitate, caprylic/capric acid triglyceride, saturated triglycerides of naturally occurring fatty acids, fatty acid esters, fatty acid esters which correspond to synthetic anatine uropygial gland fat, triglycerides, fatty alcohols, aliphatic hydrocarbons, vegetable oils, or derivatives thereof with cationic or anionic functional groups.

10. The composition of claim 7 wherein said spreading oil comprises isopropyl myristate, isopropyl palmitate, lauric acid oxalate, oleic acid oleyl ester, oleic acid decyl ester, hexyl laurate, oleyl oleate, decyl oleate, or capric acid esters of saturated fat alcohols of chain length C₁₂-C₁₈.

11. The composition of claim 7 wherein said spreading oil comprises ethyl oleate, a paraffin oil, or corn oil, sesame oil, olive oil, pine oil, linseed oil, cottonseed oil, or ground nut oil.

12. The compositon of claim 7 wherein said insecticide comprises an agonist or antagonist or the nicotinergic acetylcholine receptors of insects.

13. The composition of claim 12 wherein said insecticide comprises imidacloprid.

14. The compostion of claim 12 wherein said composition includes about 0.1 wt % imidacloprid.

15. The composition of claim 12 wherein said coating composition has been sprayed onto said fertilizer solids in an amount that does not cause agglomeration of the coated fertilizer solids.

16. The composition of claim 12 further comprising a flow aid.
